(19) United States
(12) Patent Application Publication
(10) Pub. No.: US 2026/0084635 A1
(43) Pub. Date: Mar. 26, 2026

(54) Grommet Apparatus

(71) Applicant: Illinois Tool Works Inc., Glenview, IL (US)

(72) Inventors: Gerit Vollmer, Linden (DE); Albert Sbongk, Niederstetten (DE)

(21) Appl. No.: 19/318,703

(22) Filed: Sep. 4, 2025

(30) Foreign Application Priority Data
Sep. 25, 2024 (DE) 10 2024 127 832.3

(51) Int. Cl. B60R 16/02; H02G 3/04; H02G 15/013

(52) U.S. Cl. CPC B60R 16/0222; H02G 3/0468; H02G 15/013

(57) ABSTRACT

A grommet apparatus is provided for the passage of lines through a substantially slot-shaped component opening. The grommet apparatus includes, among other things, a tubular, resiliently expandable cable passage portion extending along a central axis between a first end and a second end and a connection portion having a flange-like edge region surrounding the cable passage portion circumferentially for fastening the grommet apparatus in the component opening, comprising at least a plurality of first stiffening ribs that extend radially aligned outwardly circumferentially while being spaced apart from one another from one end of the cable passage portion to the central axis.

### RELATED APPLICATION

The present application claims the benefit of German Patent Application No. 10 2024 127 832.3, filed Sep. 25, 2024, each titled “Grommet Apparatus,” the contents of which are hereby incorporated by reference.

### BACKGROUND

One or more cables and, for example, also cable harnesses are generally guided through a plate of a carrier component, for example a body of a motor vehicle, using an EPDM grommet (grommet apparatus).

The main task of these grommets is, on the one hand, to seal the respective body portions or housings against environmental factors (dust, moisture, noise) and, on the other hand, simultaneous passage and fastening of one or more cables without damage to them.

Such grommets are provided to have a central opening for the passage of one or more cables, in particular also cable harnesses. When assembling onto a plate, these must be pressed in a circular annular manner in the edge region in an assembly direction in order to connect them to a body plate. Due to the repeated pressing, relatively high assembly forces are produced in order to achieve the desired sealing effect. Therefore, such EPDM grommets usually have a very high proportion of material in the connection portion in order to ensure sufficient stability during assembly as well as during use. Through the material stiffening of the corresponding grommet portions (e.g., material thickening of the connection part at the passage section), the cables must be guided through the grommets with a suitable plug prior to assembly, and the grommets must be pushed or pulled into the respective component opening. The plugs can then only be mounted in the component (e.g., vehicle door) after the installation of the grommets and cables.

Furthermore, repeated pressing during assembly often results in the need to check a correct assembly position frequently. In order to improve the ease of assembly of such grommets, a second, harder component is also often used in order to improve the assembly behavior. The harder component is then used together with a softer component for sealing. This variant also requires a subsequent assembly of the plug.

Nevertheless, many grommets are difficult to assemble and do not provide sufficient sealing of a corresponding component opening. Some grommets collect water in the region of the sealing portion due to the design, which may lead to corrosion on the respective component or cause damage in the region of the sealing.

Commonly, cable harnesses are also passed through the plate of an automotive body using EPDM grommets. Sometimes, grommets made of TPE or 2K grommets are also used.

The main tasks of these grommets are to seal the body against environmental influences (dust, moisture, noise) and at the same time to pass and fasten cables without causing damage.

Often, passing the cable harness through a grommet also serves to guide the cable harness in a predetermined direction or to reach a predetermined cable output. This has the advantage that, even with limited design space, contact between the cable harnesses and surrounding components is avoided and there is thus protection against damage. The cable passage also allows for tight routing of the cable harness.

A cable passage arrangement is disclosed in DE 10 2018 103 016 A1. This includes an insertion opening, which is configured as a step opening, which has, at its region near a housing interior, a small step with a smaller radial extension and, in its outwardly opening region, a large step with a larger radial extension, with a connecting member having an axial passage opening, which is insertable into the insertion opening from the outside up to an installation position and can be fixed in the installation position, wherein the connecting member, in its installation position, projects through the small step of the step opening into the housing interior with an axial pin piece and projects into the large step of the step opening with an axial holding region, as well as with a cable grommet, through which a cable guided through the passage opening of the connecting member is guided outwardly and encloses a holding region with its one end and, with elastic pre-tension, radially circumferentially abuts on both a radially circumferential lateral face of the holding region as well as on a radially circumferential inner face of the large step of the step opening.

In EP 1 193 435 B1, a sealing sleeve is disclosed. This comprises a tube portion having a small diameter through which the cable or wires can be inserted, and a jaw portion having a recess or cutout that can be brought into engagement with an edge of the through-hole.

DE 3340664 A1 discloses a sealing bellows or grommet for arrangement in a body opening for the protected passage of lines and the like. The grommet comprises a bellow or grommet body consisting of an elastic plastic material, which is provided at its ends with sealing lips that are directed outwardly and/or inwardly. A stiffener ring made of a more solid material is inserted, engaged, or molded into the ends of the sealing bellows provided for arrangement in the body opening in a manner known per se in such a way that it supports the outer sealing lip from the inside with a flange part.

The problem addressed by the present disclosure is to provide a grommet apparatus for cable passage through a component opening that is simple to handle and safe and reliable to operate, and which allows pre-assembled plugs to be passed through the grommet without impairing the radial stability and sealing of the connection portion attached in the component opening.

Furthermore, a problem addressed by the present disclosure is to provide a grommet apparatus that is inexpensive and easily manufactured. A further problem addressed by the present disclosure is to simplify and consequently to improve the assemblability of such grommet apparatuses. In addition, a further problem of the present disclosure is to reliably seal a component opening against moisture and water.

### SUMMARY

The present disclosure relates to a grommet apparatus, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a perspective view of a grommet apparatus according to the present disclosure according to an exemplary example, in a top perspective view.

FIG. 1b illustrates a perspective view of a grommet apparatus according to the present disclosure according to an example, in a top perspective view.

FIGS. 2a, 2b, 2c, and 2d illustrate, respectively, a top view, a bottom view, a side view, and a front view of the grommet apparatus.

FIG. 3a illustrates a perspective cross-sectional view of the grommet apparatus as a cut plane A-A.

FIG. 3b illustrates a perspective cross-sectional view of the grommet apparatus as a cut plane B-B.

FIG. 4a illustrates a sectional representation of a detail view of the connection portion along B-B.

FIG. 4b illustrates a sectional representation of a detail view of the connection portion along A-A.

FIG. 4c illustrates a partial section of an alternative connection portion.

FIG. 5a illustrates a grommet apparatus for a door in the installed state with a door plug, and a detail view of a door plug.

FIG. 5b illustrates a top plan view of a typical sheet metal cutout in the component (e.g., vehicle door).

FIG. 5c illustrates a side view of a plug.

FIG. 5d illustrates a front view of a plug.

FIG. 6 illustrates basic outline shapes of the connection portion and the plug of the example of the present disclosure.

FIG. 7a illustrates further illustrations of an alternative example of the grommet apparatus of the present disclosure as a front perspective view.

FIG. 7b illustrates further illustrations of an alternative example of the grommet apparatus of the present disclosure as a cross-sectional perspective view along the central axis.

FIG. 7c illustrates further illustrations of an alternative example of the grommet apparatus of the present disclosure as a bottom perspective view.

FIG. 7d illustrates further illustrations of an alternative example of the grommet apparatus of the present disclosure as a top view.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Furthermore, unless stated otherwise, the use of ordinal adjectives such as “first,” “second,” “third,” etc. only indicates different instances of the same objects and does not mean that these objects have to be in any particular order, either temporally, spatially, or in any particular order of precedence.

The present disclosure relates to a grommet apparatus for the passage of lines, in particular for passing cables and plugs, or for passing cable harnesses or fluid lines, through a component opening. In particular, the present disclosure relates to a grommet apparatus made of a thermoplastic elastomer (TPE) for vehicle doors.

According to the present disclosure, and in particular according to a first example of the present disclosure, a grommet apparatus for the passage of lines is provided on a substantially slot-shaped component opening. It comprises a tubular, resiliently expandable cable passage portion extending along a central axis between a first end and a second end and a connection portion having a flange-like edge region surrounding the cable passage portion circumferentially for fastening the grommet apparatus in the component opening. The connection portion further comprises at least a plurality of first stiffening ribs that extend radially aligned outwardly circumferentially while being spaced apart from one another from one end of the cable passage portion to the central axis.

The connecting of the grommet apparatus to a component, for example a body panel or a vehicle door, takes place in an assembly direction.

An assembly direction is understood to mean a direction that extends orthogonally to an edge region of a component that limits a passage opening of a component. That is to say, the fastening between the grommet apparatus and the component is achieved via a pressing between the grommet apparatus and the edge region of the component opening.

It has been found that there is a significant need for improvement not only in the assembly of grommets, but also in the number of necessary steps to install cables and corresponding plugs in the vehicle. Because conventional grommets are pressed radially at the edge into the component opening for sufficient sealing, the grommets, or at least the connection portion, must be designed to be relatively solid. This not only results in a high weight and additional unnecessary material costs, but increasingly stiffens the connection portion and the passage portion. Due to the material stiffening, it is therefore not possible to widen the grommet sufficiently in order to then be able to pull through a cable and a pre-assembled plug in a single step. This makes the conventional assembly very time-consuming, because the cable or the cable harness must first be inserted into the component opening with the screwed-on grommet before the plug can be connected to the cable or cable harness. Furthermore, corresponding grommets are usually formed from EPDM, which is relatively soft and has a sticky face in order to achieve the desired sealing properties. To this end, a second hard component is often used in the prior art in order to stiffen the grommets. However, this is made of a different material than the rest of the grommet apparatus, which in turn leads to higher production costs.

The grommet apparatus according to the disclosure is wherein the connection portion is provided with radially aligned stiffening ribs that are circumferentially spaced apart from one another opposite the central axis of the cable passage portion. These stiffening ribs not only provide a higher axial stability grommet (i.e., along the central axis of the tubular cable passage portion), but also achieve a better radial stiffening and stability of the connection portion (i.e., in the direction of the edge of the component opening when in situ) without affecting the expansion behavior of the grommet. In this way, cables with respectively pre-assembled plugs can be simply passed through the grommet in a single step and then inserted in the component opening in a sealing and pressing manner.

This significantly simplifies the installation and reduces the time needed.

In addition, the stiffening structure (i.e., stiffening ribs) helps to ensure that the region of the grommet located in the assembly direction does not deform so easily compared to the grommet apparatuses known from the prior art, which leads to higher holding forces and a better sealing (in the case of pressing) in the component opening.

Furthermore, the spaced apart radial arrangement of the stiffening ribs significantly improves the even distribution of the pressing forces that are necessary for sealing on the component opening edge.

The contour profile of the edge region of the connection portion is configured to complement the contour profile of the component opening in such a way that the connection portion can be attached in the component opening by way of radial pressing with a relatively uniform pressure distribution. Preferably, the contour profile of edge region is substantially slot-shaped or oval-shaped, wherein the edge region of the connection portion is formed from two opposed first side edges and two opposed second side edges, respectively, wherein the second side edges are longer than the first side edges, and the first side edges and/or second side edges are each domed outwardly.

Accordingly, the contour profile of the connection portion is configured to the contour profile of the component opening so that the connection portion can be secured in the opening in a sealing manner, wherein the pressing push forces are evenly distributed on the opening edge. The outwardly domed side edges of the connection portion allow for optimized contact between the connection portion and the opening edge, resulting in improved compression and sealing.

Advantageously, the connection portion comprises at least one second stiffening rib, which at least partially radially surrounds the cable passage portion in a circumferential manner and is substantially orthogonally aligned in relation to the first stiffening ribs.

The grommet apparatus where the connection portion comprises a fastening portion, wherein the fastening portion comprises at least one radially circumferentially arranged locking means for rearwardly engaging with an edge of the component opening lying in the assembly direction.

The connection portion can comprise a sealing portion and a fastening portion. With the sealing portion of the connection portion, a seal is achieved in the connection region between the grommet apparatus and the component opening.

The radially circumferential fastening portion can comprise a locking means for rearward engagement of an edge of a component lying in the assembly direction. By means of the fastening portion, the grommet apparatus can be connected to a component opening. The locking means can have a locking edge arranged counter to the direction of assembly. In this way, radially circumferentially identical holding forces are provided for connecting to a component opening of a component, and the grommet apparatus according to the disclosure can be produced integrally in a simple manner by means of a corresponding injection molding method.

The sealing portion can further have a radially circumferential sealing lip that extends substantially in the assembly direction. A reliable sealing of the component opening by means of the grommet apparatus is achieved among other things by means of the sealing lip. A sealing lip that extends substantially in the assembly direction is understood to lie primarily in the assembly direction on a component opening; however, it also naturally can have a component that extends outward in the radial direction.

The substantially U-shaped cross-sectional profile of the connection portion and the molded sealing lip causes a radial and axial pre-tensioning in the connection portion, which improves the contact when engaging with the component opening.

Optionally, the cable passage portion is arranged eccentrically circumferentially at one end of the cable passage portion. The eccentric arrangement between the cable passage portion and the connection portion optimizes the cable position in the vehicle door when the pre-assembled plug is of irregular shape and the cables are positioned offset from the plug center point.

Preferably, the connection portion is configured integrally with the cable passage portion.

The grommet apparatus can be formed from a thermoplastic elastomer (TPE), for example.

With the grommet apparatus formed from an elastomer or thermoplastic elastomer, according to the disclosure, it is possible to form the grommet apparatus from a single material, despite improved properties. Grommets with a stiffening wall known from the prior art are usually made of two different materials in a corresponding two-component injection molding process. Also, it is no longer necessary to use EPDM parts for grommet apparatuses.

This makes manufacturing easier and reduces production costs.

The example of an example of the grommet apparatus 100 described herein is representative of all possible variations of the disclosure.

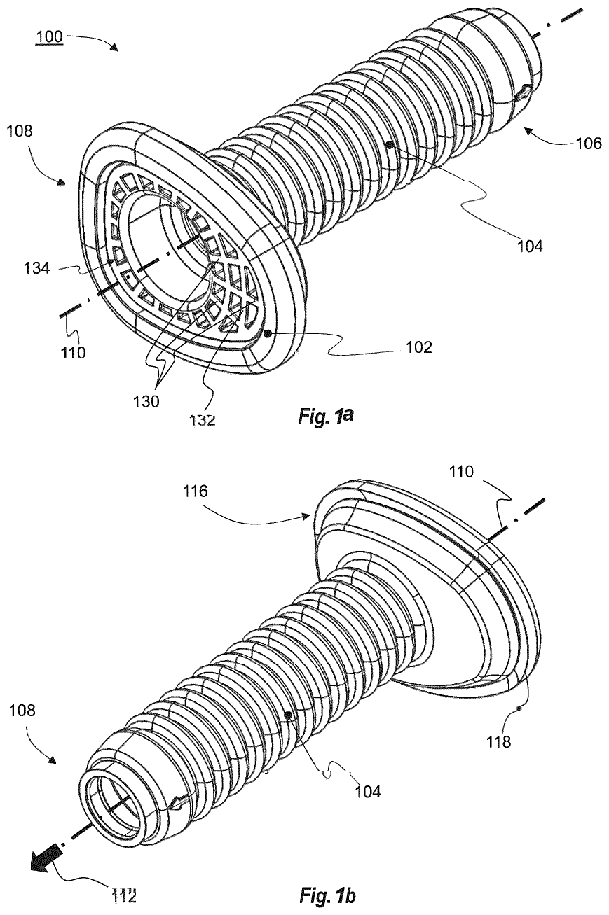

A grommet apparatus 100 according to the disclosure for the passage of lines through a component 200 is described in more detail in the following on the basis of an example and with reference to FIGS. 1 to 5. FIGS. 1a and 1b illustrate perspective views of a grommet apparatus according to the present disclosure, shown in exemplary and example forms, respectively, from a top perspective view.

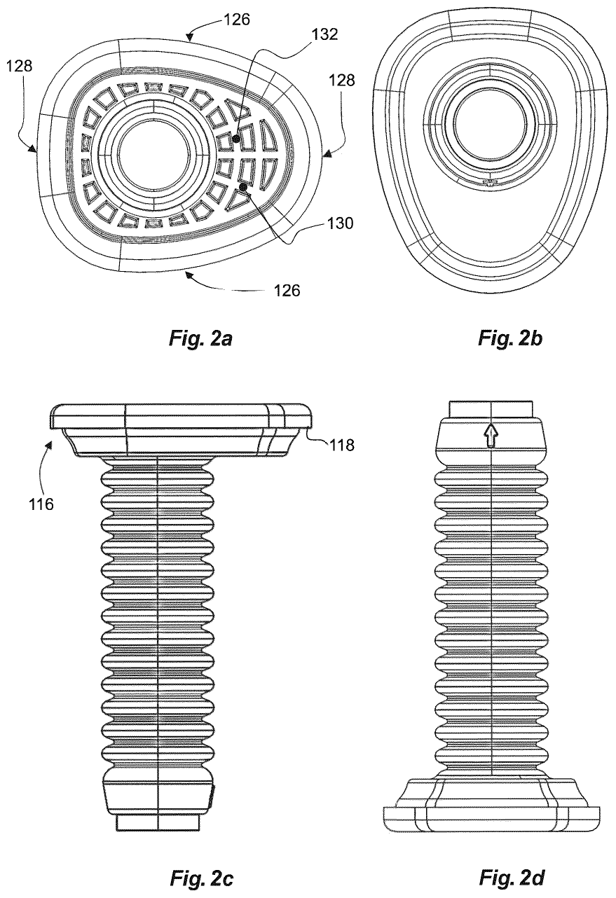

FIGS. 2a through 2d illustrate, respectively, a top view, bottom view, side view, and front view of the grommet apparatus, providing multiple orthogonal perspectives of the structure.

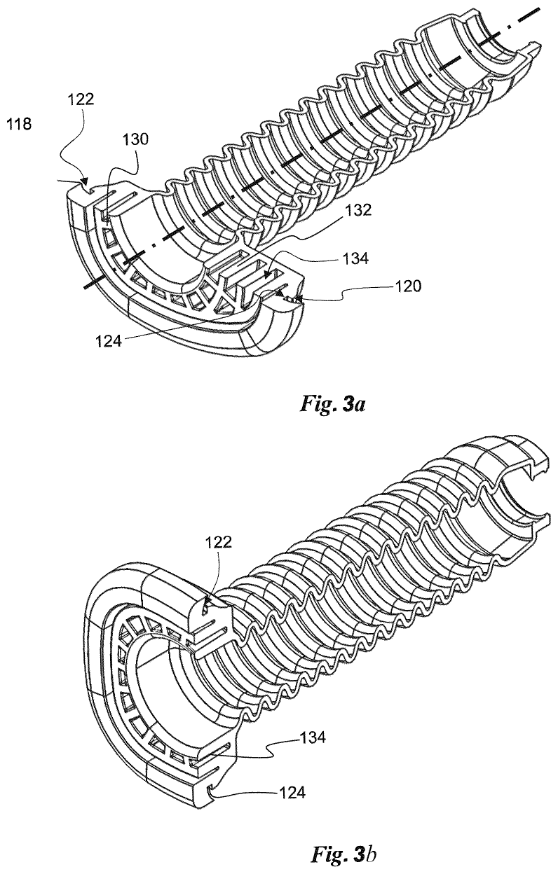

FIGS. 3a and 3b illustrate perspective cross-sectional views of the grommet apparatus, taken along cut planes A-A and B-B, respectively.

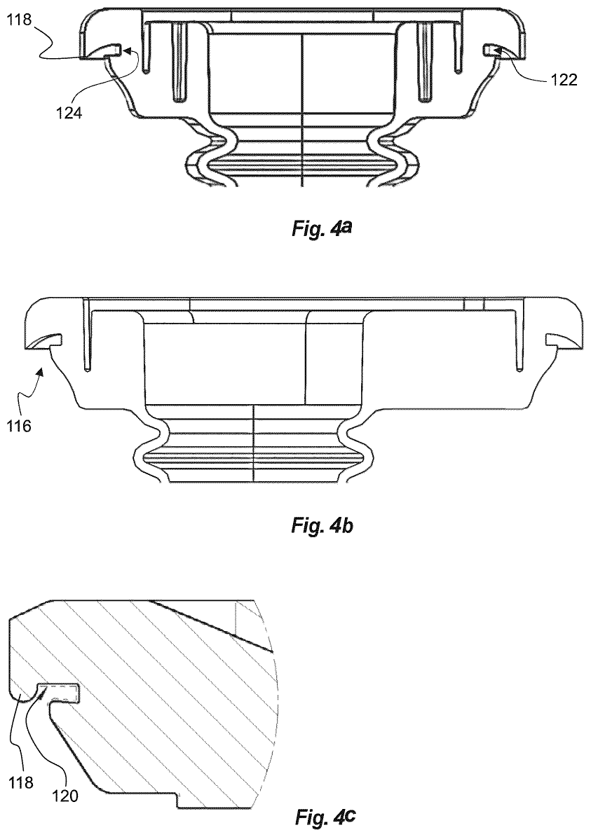

FIGS. 4a and 4b illustrate sectional representations of detail views of the connection portion along cut planes B-B and A-A, respectively. FIG. 4c illustrates a partial section of an alternative connection portion.

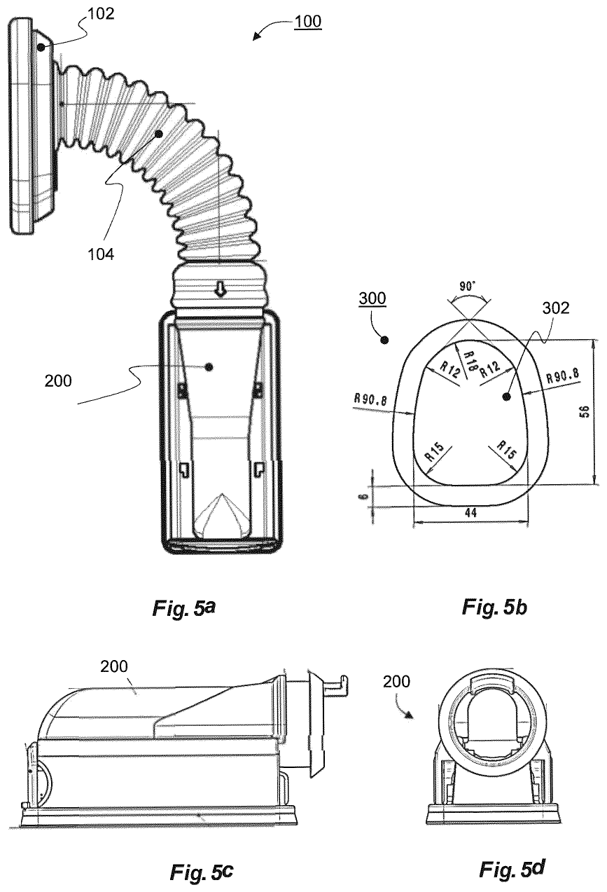

FIG. 5a illustrates the grommet apparatus for a door in the installed state with a door plug, including a detail view of the door plug. FIGS. 5b through 5d illustrate, respectively, a top plan view of a typical sheet metal cutout in a component (e.g., a vehicle door), a side view of a plug, and a front view of a plug.

The grommet apparatus 100 comprises a connection portion 102 for connecting the grommet apparatus 100 to an edge region of a component opening 302 and an elastically deformable tubular cable passage portion 104 extending between a proximal end 106 (relative to the connection portion 102) and a distal end 108 (relative to the connection portion 102) along a central axis 110. FIG. 5(b) shows a possible example of a component opening 302 in a component panel 300, but it is clear to the person skilled in the art that the opening 302 can have any outline that is suitable for a passage of a plug 200 and one or more cable(s) mounted accordingly (not shown). In the example specified, the outline shape is substantially slot-shaped, or also oval-shaped, or camshaft-shaped, such that the irregularly shaped plug 200 used here fits through in accordance with its shape. However, it is clear to the person skilled in the art that for differently shaped plugs, component openings and connection portions having corresponding shape-appropriate outlines are used.

The connection portion 102 is arranged in an integrated manner with the cable passage portion 104 at the proximal end 106 of the cable passage portion 104 in a flange-like manner while surrounding the center axis 110 circumferentially.

The grommet apparatus 100 is provided for insertion into the component opening 302 in an assembly direction 112.

The connection portion 102 comprises a sealing portion 114 and a fastening portion 116.

The sealing portion 114 comprises a circular annular sealing lip 118, which extends substantially in the assembly direction 112. In an initial state, the sealing lip 6 extends approximately in the direction of assembly 112. However, the sealing lip 118 can also extend at an angle from the mounting direction 112. In the present example, the sealing lip 118 forms a U-shaped cut profile with the connection portion 102.

The fastening portion 116 comprises a locking means integrally molded on as a locking edge 120. The radially circumferential locking edge 120 is provided for rearwardly engaging with an edge of a component 300 lying in the assembly direction 112. That is to say, the locking edge 120 faces the assembly direction 112 and extends approximately transversely thereto.

The locking edges 120 and part of the sealing lip 118 form a circumferential groove 122 with a pressing face 124 that lies in the direction of a circumferential face of the component opening 302. The outline of the pressing face 124 corresponds approximately to the outline shape of the component opening 203, wherein the pressing face 124 elastically presses in a pre-tensioned manner against the circumferential face of the component opening 302 when the connection portion 102 is engaged in the component opening 302. That is to say, the water resistance (e.g., IPX6K) is primarily achieved by the radial pre-tensioning of the elastic connection portion 102 (through the radially oriented pressing face 124). In this example, the sealing lip 118 serves only as an additional protection against external influences, but in other examples the sealing lip 118 can also have a sealing effect.

In the described example, the connection portion 102 is largely slot-shaped or oval-shaped. The outline of the connection portion 102 has two opposed first and second side edges, 126, 128, respectively, wherein the first side edges 126 are longer than the second side edges 128. The first and second side edges 126, 128 are additionally domed outwards. The curvature allows for better pressing with the circumferential face of the component opening 302, e.g., when the doming of the side edges 126, 128 is pressed in an elastically deforming manner onto a rectilinearly shaped side face of the component opening.

As shown in particular in FIG. 2(a) and 3(a), (b), the connection portion 102 comprises a number of first stiffening ribs 130 that extend radially outwardly, being circumferentially spaced apart from one another relative to the center axis 110, i.e., from the proximal end 106 of the cable passage portion 104 to a circumferential edge region of the connection portion 102. The relatively thin-walled nature of the resiliently deformable connection portion 102 and corresponding clearances 134 between the first stiffening ribs 130 allows for a sufficiently radial expansion of the connection portion 102 and the integrally molded cable passage portion 104, so that a cable with a pre-assembled plug 200 can be pulled through the grommet apparatus 100 in a simple step to then be installed into the door opening 302 in a pressing manner. The radially aligned first stiffening ribs 130 can be additionally supplemented with one or more orthogonally aligned circumferential second stiffening rib(s) 132. The braided first and second stiffening ribs 130, 132 form cutouts or cavities 134 corresponding to the expansion.

Accordingly, the rib structure 132, 134 according to the disclosure allows for a sufficient radial expansion of the cable passage portion 104 and the connection portion 102, wherein the reinforcing ribs 132, 134 can further cause an axial stiffening of the connection portion 102.

As shown in FIG. 5(a), for example, in the context of the present disclosure, the cable passage portion 104 is configured for receiving one or more electrical cables with a pre-assembled plug 200 or for receiving one or more lines or hoses (i.e., fluid lines) with pre-assembled connecting pieces. FIG. 5(a) shows a cable with a pre-assembled plug 200 passed through the grommet apparatus 100. FIG. 5(b) shows one example of a suitable component opening 302 in a component 300, e.g., a vehicle door. FIG. 5(c) and (d) show an example of a plug shape (side view and front view) that fits through the oval or slot-shaped component opening (FIG. 5(b)).

For example, the grommet apparatus 100 is made of an integrally and elastically deformable thermoplastic elastomer. In the described example, the cable passage portion 104 is integrally molded onto a slot-shaped or oval-shaped connection portion 102 in an eccentric manner. The eccentric arrangement between the connection portion and the cable passage portion 104 and the correspondingly configured outline shape of the connection portion 102 serve to accommodate the plug shape described herein.

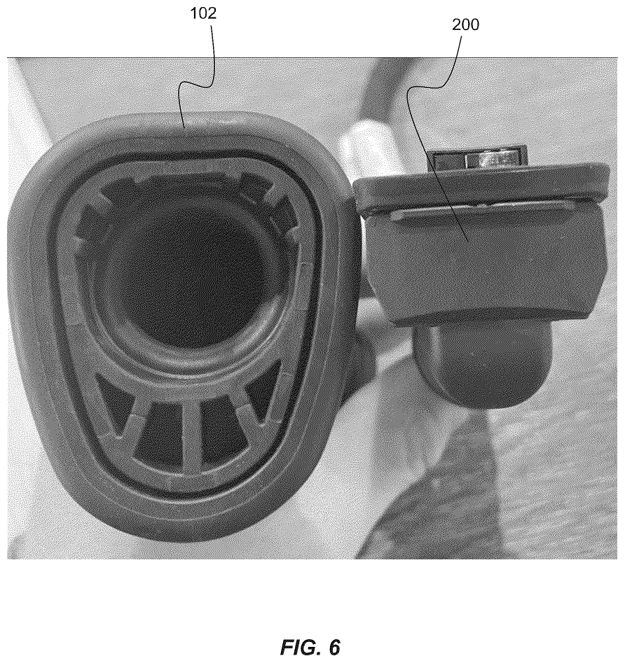

It is clear to the person skilled in the art that the relative arrangement between the connection portion 102 and the cable passage portion 104 as well as the floor plan shape of the connection portion 102 and the component opening are insignificant and only serve to guide a special outline shape of a pre-assembled plug 200 through the grommet apparatus 100, which is then fastened in the component opening in a sealing manner. Other plug shapes require different arrangements and/or outline shapes, respectively. Examples of the outline shapes of the connection portion 102 and the plug 200 are shown in FIG. 6.

FIG. 6 illustrates basic outline shapes of the connection portion and the plug in accordance with the example of the present disclosure.

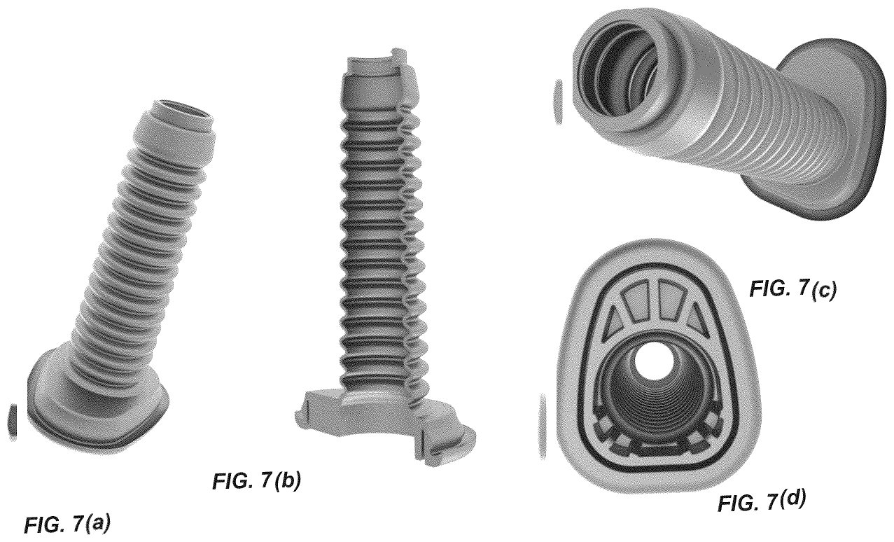

FIGS. 7a through 7d show an alternative example of the grommet apparatus of the present disclosure, with a different rib structure of the connection portion. Specifically, FIGS. 7a through 7d illustrate further examples of an alternative grommet apparatus according to the present disclosure, including a front perspective view (7a), a cross-sectional perspective view along the central axis (7b), a bottom perspective view (7c), and a top view (7d).

According to a method of manufacture according to the disclosure, the grommet apparatus 100 is made of a thermoplastic elastomer (TPE), preferably integrally, by means of a single-component injection molding process.

For application, the grommet apparatus 100 is simply elastically expanded (by the user or by a tool) to then be pulled over a plug 200 that is pre-mounted on a cable. The grommet apparatus 100 pulled through along with the cable and plug 200 is then drawn (or pressed) through the component opening 302 of the vehicle door 300 in the direction of assembly 110 until the fastening portion 116 of the connection portion 102 locks into the component opening in a fastening and sealing manner.

### LIST OF REFERENCE NUMERALS

100 Grommet apparatus
102 Connection portion
104 Cable passage portion
106 Proximal end
108 Distal end
110 Central axis
112 Assembly direction
114 Sealing portion
116 Fastening portion
118 Sealing lip
120 Latching edge
122 Circumferential groove
124 Pressing face
126 First side faces
128 Second side faces
130 First stiffening ribs
132 Second stiffening ribs
134 Cutouts, cavity
200 Plug
300 Component
302 Component opening

What is claimed is:

1. A grommet apparatus for the passage of lines through a substantially slot-shaped component opening, comprising:
a tubular, resiliently expandable cable passage portion extending along a central axis between a first end and a second end;
a connection portion having a flange-like edge region surrounding the cable passage portion circumferentially for fastening the grommet apparatus in the component opening, comprising at least a plurality of first stiffening ribs that extend radially aligned outwardly circumferentially while being spaced apart from one another from one end of the cable passage portion to the central axis.

2. The grommet apparatus according to claim 1, wherein the contour profile of the edge region of the connection portion is configured to complement the contour profile of the component opening in such a way that the connection portion can be attached in the component opening by way of radial pressing.

3. The grommet apparatus according to claim 1, wherein the contour profile of the edge region is substantially slot-shaped or oval-shaped.

4. The grommet apparatus according to claim 1, wherein the edge region of the connection portion is formed from two opposed first side edges and two opposed second side edges, respectively, wherein the second side edges are longer than the first side edges, and the first side edges and/or second side edges are each domed outwardly.

5. The grommet apparatus according to claim 1, wherein the connection portion comprises at least one second stiffening rib, which at least partially radially surrounds the cable passage portion in a circumferential manner and is substantially orthogonally aligned in relation to the first stiffening ribs.

6. The grommet apparatus according to claim 1, wherein the connection portion comprises a fastening portion, wherein the fastening portion comprises at least one radially circumferentially arranged locking means for rearwardly engaging with an edge of the component opening lying in the assembly direction.

7. The grommet apparatus according to claim 6, wherein the locking means comprises a locking edge arranged counter to the direction of assembly.

8. The grommet apparatus according to claim 1, wherein the connection portion comprises a sealing portion, wherein the sealing portion comprises a radially circumferential sealing lip extending substantially in the direction of assembly.

9. The grommet apparatus according to claim 1, wherein the cable passage portion is arranged eccentrically circumferentially on one end of the cable passage portion.

10. The grommet apparatus according to claim 1, wherein the connection portion is integrally formed with the cable passage portion.
